(19) United States
(12) Patent Application Publication
(10) Pub. No.: US 2008/0007127 A1
(43) Pub. Date: Jan. 10, 2008

(54) Shock prevention structure for motor

(75) Inventors: Alex Hong, Kaohsiung City (TW); Chang Shih Huang, Kaohsiung City (TW)

Correspondence Address: BACON & THOMAS, PLLC, 625 SLATERS LANE, FOURTH FLOOR, ALEXANDRIA, VA, 22314, US

(73) Assignee: Sunonwealth Electric Machine Industry Co., Ltd., Kaohsiung City (TW)

(21) Appl. No.: 11/493,520

(22) Filed: Jul. 27, 2006

(30) Foreign Application Priority Data
Jul. 4, 2006 (TW) 95124303

(51) Int. Cl. H02K 5/24; H02K 7/00; H02K 5/16

(52) U.S. Cl. 310/51; 310/90; 310/67 R

(57) ABSTRACT

The present invention relates to a motor shock prevention structure, which provides a plurality of shock prevention elements enclosed by the inner wall of a shaft tube and the outer wall of a bearing to disengage the bearing from the shaft tube. The shock-absorbent element shall be made of a flexible material being shock-absorbent and damping. Therefore, when a motor rotates, the vibration amplitude generated by rotation of a rotor is isolated and damped by the shock-absorbent elements. Thus, the vibration amplitude won't be transmitted to a base, and the efficacy of electronic system won't be compromised, such that the resonant effect, the vibration and the noise of electronic system can be prevented and the normal efficacy and the operation life span of electronic system can be secured.

### FIELD OF THE INVENTION

The present invention relates to a shock prevention structure for motor, and more particularly to one capable of isolating and alleviating the vibration caused by rotation of motor rotor and transmitted to a base and an electronic system, ensuring to protect the electronic system and secure the normal efficacy and operation life span thereof.

### BACKGROUND OF THE INVENTION

As shown in FIG. 1, a motor structure includes a base 11, a stator set 20 and a rotor 30, wherein a shaft tube 12 is centrally disposed on the base 11, the stator set 20 is disposed on the periphery of the shaft tube 12.

Moreover, at least a bearing 40 is disposed in the shaft tube 12 so that a rotational shaft 31 of the rotor passes through the bore of the bearing 40 and is supported by the bore to rotate therein.

Whereas, when the aforementioned motor structure is actually applied in electronic system for heat dissipation, few drawbacks are still present, making electronic system fail to perform its optimized performance. Those drawbacks are concluded as follows:

1. Resonant effect generated by electronic system: When motor rotates, the vibration generated by the rotor 30 and the vibration generated by attrition between the rotational shaft 31 and the bearing 40 will be transmitted through the bearing 40 and the shaft tube 12 to the base 11 and further to electronic system. Consequently, electronic system will result in a severe resonant effect and noise out of vibration. Moreover, the electronic system consistently located at a vibrating environment may further accelerate the fatigue and the aging of the contact point of the internal component and shorten the life cycle of the electronic system.

2. Severe vibration and noise generated by electronic system: The enormous noise arising from the resonant effect of electronic system significantly affects the overall noise value assessment of electronic system.

As such, to completely solve the resonant effect issue of electronic system and maintain the normal efficacy and the life cycle of electronic system, developing a motor shock prevention structure is indispensable.

### SUMMARY OF THE INVENTION

In view of the forgoing concern, the present invention provides a motor shock prevention structure, wherein a shaft tube is disposed in a base, a stator set is disposed on the periphery of the shaft tube, a bearing is disposed inside the shaft tube for supporting a rotational shaft to rotate therein, and a rotor is fixed on a top end of the rotational shaft.

The shock prevention structure has at least a shock prevention element angularly disposed between the inner wall of the shaft tube of the motor and the outer wall of the bearing to disengage the bearing from the shaft tube. Besides, the shock prevention element shall be made of a flexible material having shock-absorbent and damping features.

Given the shock prevention structure, the vibration amplitude arising from rotation of motor rotor and the vibration amplitude generated from attrition between the rotational shaft and the bearing won't be directly transmitted to the base by virtue of the isolating and damping functions of the shock prevention element. Accordingly, the efficacy of the electronic system won't be affected, and the resonant effect and the noise out of vibration of the electronic system can be further avoided to maintain the normal efficacy and operation life span of electronic system.

### BRIEF DESCRIPTION OF THE DRAWINGS

FIG. 1 is a cross-sectional view showing a conventional shock prevention structure;

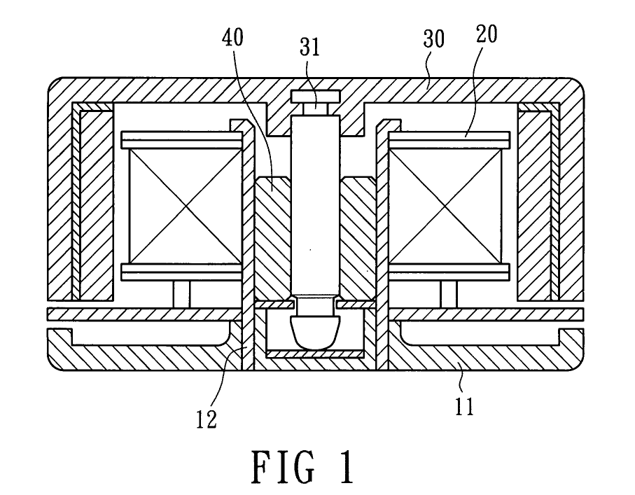

FIG. 2 is a cross-sectional view showing a motor with radial windings implemented for sleeve bearing of the present invention;

FIG. 3 is a cross-sectional view showing a motor with coaxial windings implemented for sleeve bearing of the present invention;

FIG. 4 is a cross-sectional view showing the other preferred embodiment of the present invention; and

FIG. 5 is a cross-sectional view showing a ball bearing motor implemented in the present invention.

### DETAILED DESCRIPTION OF THE PREFERRED EMBODIMENT

The present invention relates to a motor shock prevention structure, which has a shock prevention element with shock-absorbent and damping features disposed between the inner wall of a shaft tube and the outer wall of a bearing of a motor. The mentioned bearing may be either type of a sleeve bearing or a ball bearing, ensuring that the vibration amplitude arising from the rotation of a motor rotor and the vibration amplitude generated from attrition between a rotational shaft and a bearing won't be directly transmitted to a base fastened by the shaft tube, thereby isolating the impact of the vibration amplitude from an electronic system.

Several preferred embodiments illustrated hereafter in the present invention are applicable to a sleeve bearing motor and a ball bearing motor.

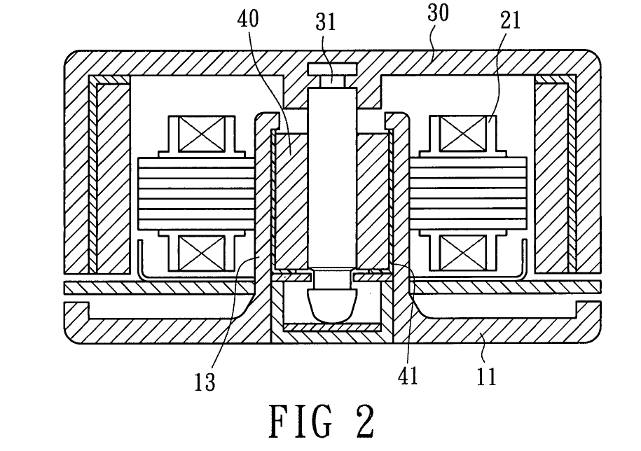

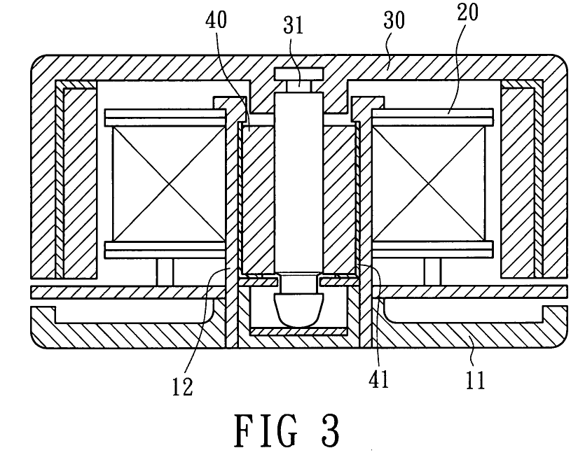

FIG. 2 and FIG. 3 are the preferred embodiments of the present invention showing a motor with axial windings and a motor with radial windings applied to a sleeve bearing respectively. The two motor structures are roughly the same and their difference lies in the winding patterns of the stator sets 20, 21 and the distinction of the shaft tubes 12, 13.

The motor structure mainly includes a base 11, the stator set 20, 21 and a rotor 30.

The shaft tube 12, 13 is centrally disposed in the base. As illustrated in FIG. 2, the shaft tube 13 of the motor with radial windings is integrally extended from the base 11 and is made of a plastic material. As illustrated in FIG. 3, the shaft tube 12 of the motor with axial windings is a metal tube embedded in the base 11, and the stator set 20, 21 is disposed on the periphery of the shaft tube 12, 13.

At least a bearing 40 is disposed in the shaft tube 12, 13 such that a rotational shaft 31 of the rotor 30 passes through the bore of the bearing 40 and is supported by the bore to rotate therein.

A plurality of shock-absorbent elements 41 are sandwiched by the inner wall of the shaft tube 12, 13 and the outer wall of the bearing 40. The shock-absorbent element 41 shall be made of a flexible material having shock-absorbent and damping features, such as rubber, polyurethane and the like. The shock-absorbent elements 41 in the preferred embodiment have two L-shaped cross sections symmetrically positioned and facing inwardly to envelop the periphery of the bearing and the bottom surface of the bearing in contact with the retainer ring, such that the bearing 40 and the shaft tube 12, 13 won't be directly contacted.

Accordingly, when a motor rotates, the vibration amplitude generated by rotation of the rotor 30 and the vibration amplitude generated by attrition between the rotational shaft 31 and the bearing 40 can be isolated and damped by the shock-absorbent element 41, such that the vibration amplitude won't be transmitted to the base. As a result, the efficacy of electronic system won't be affected, and the resonant effect, the vibration and the noise of electronic system can be prevented so as to maintain the normal efficacy and the operation life span of electronic system.

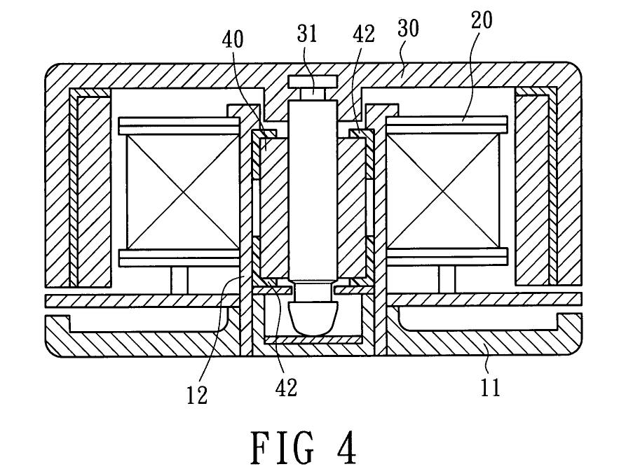

Illustrated in FIG. 4 is another preferred embodiment of the present invention applied to a sleeve bearing motor. A shock-absorbent element 42 is disposed at a top location and a bottom location respectively between the inner wall of a shaft tube 12 and the outer wall of a bearing 40. The shock-absorbent element 42 shall be made of a flexible material having shock-absorbent and damping feaures, such as rubber, polyurethane and the like. Two cross sections of the shock-absorbent elements 42 are L-shaped and face inwardly, and the shock-absorbent elements 42 envelops the periphery, the top surface and the bottom surface of the bearing, such that the bearing 40 and the shaft tube 12 won't be directly contacted. Moreover, the space formed and supported between two shock-absorbent elements 42 capable of storing lubricant improves the abrasive loss issue of the rotational shaft 31 and the bearing 40.

Likewise, the vibration amplitude generated by rotation of the rotor 30 and the vibration amplitude generated by attrition between the rotational shaft 31 and the bearing 40 can be isolated and damped, such that the severe resonant effect, the vibration and the noise generated by electronic system can be prevented.

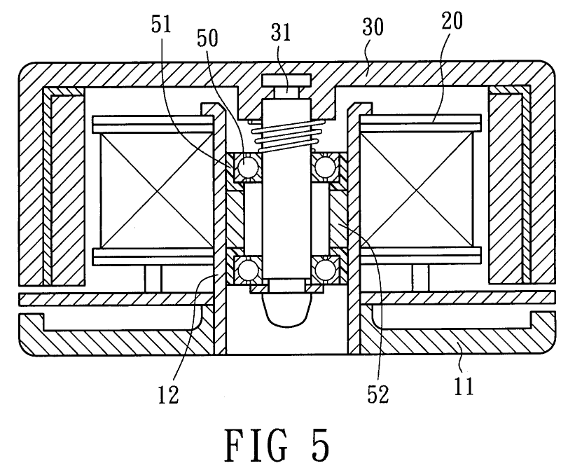

As shown in FIG. 5, when the present invention is applicable to a ball bearing motor, at least a bearing 50 (two bearings allocated in FIG. 5) is disposed inside the shaft tube 12. A retainer ring 52 is disposed between the two bearings 50 for separating and limiting the two bearings 50, and a plurality of shock-absorbent elements 51 are sandwiched by the inner wall of the shaft tube 12 and the outer wall of the bearing 50.

The shock-absorbent elements 51 of the preferred embodiment are enclosed by the contacted surfaces of the bearing, the inner wall of the shaft tube 12 and the retainer ring 52, and the two cross sections of the shock-absorbent elements 51 are L-shaped and face outwardly so as to prevent the two bearings 50 and the shaft tube from being directly contacted. As such, electronic system can be prevented from generating the severe resonant effect, the vibration and the noise. When comparing the shock-absorbent structure of the present invention with the aforementioned conventional structure, the characteristics of the present invention at least include:

1. No resonant effect: The vibration amplitude generated by rotation of the rotor and the vibration amplitude generated by attrition between the rotational shaft and the bearing can be isolated and damped by the shock-absorbent element, such that the vibration amplitude can be prevented from being transmitted to electronic system and the resonant effect generated by electronic system is further avoided.

2. No resonant noise: The shock-absorbent element not only isolates and damps the vibration to prevent electronic system from generating resonant effect but also avoids to generate resonant noise.

3. Assurance of optimized efficacy and operation life span of electronic system: When electronic system is no longer subject to the vibration out of motor operation, electronic system can make most of its efficacy so as to maintain normal operation life span thereof.

In sum, the present invention positively addresses the above-mentioned advantages and provides substantial efficacy as well in comparison with the conventional structure. Therefore, the present invention not only has a novelty and a progressiveness, but also has an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A motor shock prevention structure, comprising:
a base;
a shaft tube disposed on said base;
a stator set disposed on the periphery of said shaft tube;
at least a bearing disposed inside said shaft tube for supporting a rotational shaft to rotate therein;
a rotor fixed on the top end of said rotational shaft; and
at least a shock-absorbent element disposed between the inner wall of said shaft tube and the outer wall of said bearing to disengage said bearing from said shaft tube and made of a flexible material being shock-absorbent and damping.

2. The motor shock prevention structure of claim 1, wherein said shock prevention element is made of rubber.

3. The motor shock prevention structure of claim 1, wherein said shock prevention element is made of polyurethane.

4. The motor shock prevention structure of claim 1, wherein said bearing is a sleeve bearing.

5. The motor shock prevention structure of claim 4, wherein said shock-absorbent elements have two L-shaped cross sections symmetrically arranged and facing inwardly to envelop the periphery of said bearing and the bottom surface of said bearing in contact with a snap ring.

6. The motor shock prevention structure of claim 4, wherein said shock-absorbent elements have two L-shaped cross sections disposed at a top location and a bottom location respectively between the inner wall of said shaft tube and the outer wall of said bearing and symmetrically arranged and facing inwardly to envelop the periphery, the top surface and the bottom surface of said bearing.

7. The motor shock prevention structure of claim 6, wherein a space formed and supported between two shock-absorbent elements serves to store lubricant.

8. The motor shock prevention structure of claim 1, wherein said bearings are two ball bearings disposed with a retainer ring therebetween, and said shock-absorbent elements are enclosed by said bearing, the inner wall of said shaft tube and said retainer ring and have two L-shaped cross sections symmetrically arranged and facing outwardly.
